(19) United States
(12) Patent Application Publication
(10) Pub. No.: US 2026/0358636 A1
(43) Pub. Date: Nov. 12, 2026

(54) DISPLAY STRUCTURE

(71) Applicant: Dispelix OY, Espoo (FI)

(72) Inventor: Kalle VENTOLA, Joensuu (FI)

(73) Assignee: Dispelix OY, Espoo (FI)

(21) Appl. No.: 19/135,187

(22) PCT Filed: Dec. 14, 2023
(86) PCT No.: PCT/FI2023/050694

§ 371 Date: Jun. 3, 2025

(30) Foreign Application Priority Data
Jan. 5, 2023 (FI) 20235018

(51) Int. Cl. G02B 27/01; G02B 6/34

(52) U.S. Cl. CPC G02B 27/0172; G02B 6/34

(57) ABSTRACT

According to an embodiment, a display structure comprises: a first waveguide, a second waveguide, a first in-coupling structure in/on the first waveguide comprising first diffractive grating features and first sub-wavelength grating features and configured to receive a set of input beams comprising a first polarization and a second polarization, wherein the first diffractive grating features are configured to couple at least part of the first polarization into the first wave-guide, and wherein the first sub-wavelength grating features are configured to make the first diffractive grating features at least partially transparent to the second polarization, and a second in-coupling structure in/on the second waveguide configured to receive at least a part of the second polarization passed through the first in-coupling structure and to couple at least some of the part of the second polarization passed through the first in-coupling structure into the second waveguide.

### TECHNICAL FIELD

The present disclosure relates to the field of diffractive optics, and more particularly to a display structure and a display device.

### BACKGROUND

In various optical applications, such as augmented reality (AR) applications, it may be desirable to be able to couple different components, such as different wavelength ranges, of light into different waveguides. This can make the designing of the waveguide and of the optical components used to control the light in the waveguide easier.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object to provide a display structure and a display device. The foregoing and other objects are achieved by the features of the independent claims. Further implementation forms are apparent from the dependent claims, the description and the figures.

According to a first aspect, a display structure comprises: a first waveguide; a second waveguide; a first in-coupling structure in/on the first waveguide comprising first diffractive grating features and first sub-wavelength grating features and configured to receive a set of input beams comprising a first polarization and a second polarization, wherein the first diffractive grating features are configured to couple at least part of the first polarization into the first waveguide, and wherein the first sub-wavelength grating features are configured to make the first diffractive grating features at least partially transparent to the second polarization; and a second in-coupling structure in/on the second waveguide configured to receive at least a part of the second polarization passed through the first in-coupling structure and to couple at least some of the part of the second polarization passed through the first in-coupling structure into the second waveguide.

According to second aspect, a display device comprises a display structure according to the first aspect.

According to a third aspect, a diffractive grating comprises first diffractive grating features and first sub-wavelength grating features, wherein the first diffractive grating features comprise a first plurality of grating lines and the first sub-wavelength grating features comprise a second plurality of grating lines and the second plurality of grating lines are positioned between the first plurality of grating lines.

Many of the attendant features will be more readily appreciated as they become better understood by reference to the following detailed description considered in connection with the accompanying drawings.

### DESCRIPTION OF THE DRAWINGS

In the following, embodiments are described in more detail with reference to the attached figures and drawings, in which:

FIG. 1 illustrates a schematic representation of a display structure according to an embodiment;

FIG. 2 illustrates a schematic representation of an in-coupling structure according to an embodiment;

FIG. 3 illustrates a schematic representation of an in-coupling structure according to another embodiment;

FIG. 4 illustrates a schematic representation of in-coupling structures and polarizations according to an embodiment;

FIG. 5 illustrates a schematic representation of a waveguide according to an embodiment; and

FIG. 6 illustrates a schematic representation of a display device according to an embodiment.

In the following, identical reference signs refer to similar or at least functionally equivalent features.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

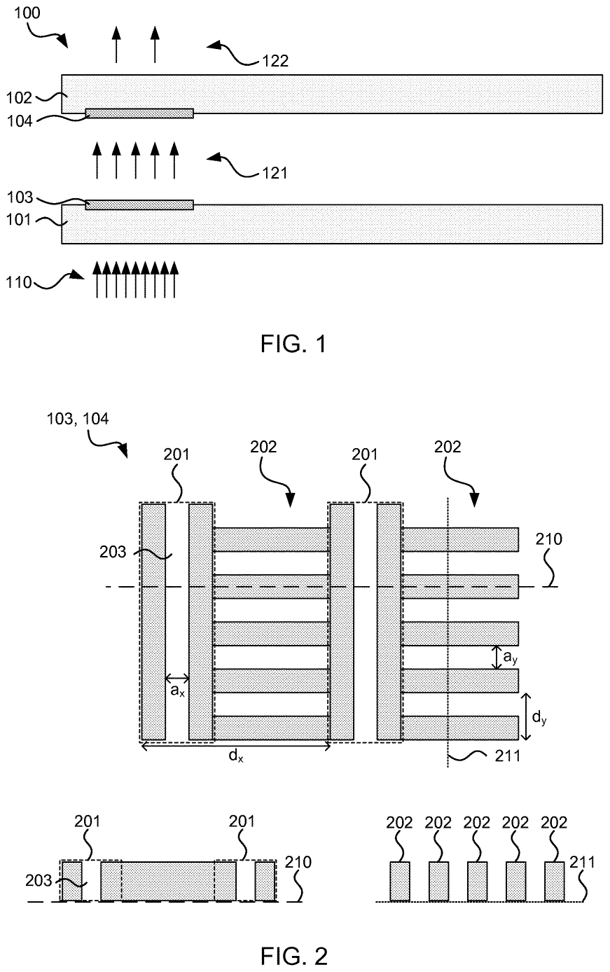

FIG. 1 illustrates a schematic representation of a display structure according to an embodiment.

According to an embodiment, a display structure 100 comprises a first waveguide 101 and a second waveguide 102.

The first waveguide 101 and/or the second wave-guide 102 may comprise, for example, a substantially planar waveguide. Alternatively or additionally, the first waveguide 101 and/or the second waveguide 102 may also comprise curved sections. For example, first waveguide 101 and/or the second waveguide 102 correspond to a lens of augmented reality (AR) glasses. For example, each of the first waveguide 101 and the second waveguide 102 may correspond to a layer of such AR glasses.

The display structure 100 may further comprise a first in-coupling structure 103 in/on the first waveguide 101 comprising first diffractive grating features and first sub-wavelength grating features and configured to receive a set of input beams 110 comprising a first polarization and a second polarization, wherein the first diffractive grating features are configured to couple at least part of the first polarization into the first waveguide 101, and wherein the first sub-wavelength grating features are configured to make the first diffractive grating features at least partially transparent to the second polarization.

The first polarization may also be referred to as a first linear polarization. The second polarization may also be referred to as a second linear polarization.

Herein, diffractive grating features may refer to grating features that have a spatial periodicity of the same order of magnitude or greater than the smallest wavelength of the set of input beams 110. Alternatively or additionally, sub-wavelength grating features may refer to grating features that have a spatial periodicity of the same order of magnitude or less than the smallest wavelength of visible light, such as less than 380 nanometres (nm).

Alternatively or additionally, diffractive grating features may refer to grating features that have a spatial periodicity, which, in the used incidence mounting, allows propagating diffraction orders, in either reflected or transmitted light, to emerge.

Alternatively or additionally, sub-wavelength grating features may refer to grating features that have a spatial periodicity, which, in the used incidence mounting, does not allow diffraction orders to emerge.

The sub-wavelength grating features may also be referred to as zeroth order grating features.

Herein, sub-wavelength grating features may refer to grating features that have a spatial periodicity smaller than the smallest wavelength of the set of input beams 110. Alternatively or additionally, sub-wavelength grating features may refer to grating features that have a spatial periodicity smaller than the smallest wavelength of visible light, such as smaller than 380 nm.

Since the first diffractive grating features are configured to couple at least part of the first polarization into the first waveguide 101, some part of the first polarization can also pass through the first in-coupling structure 103 and/or the first waveguide 101.

Since the first sub-wavelength grating features can make the first diffractive grating features at least partially transparent to the second polarization, at least a part of the second polarization can pass through the first waveguide 101 onto the second waveguide 102.

For example, as illustrated in the embodiment of FIG. 1, some light 121 can pass through the first in-coupling structure 103 and the first waveguide 101.

The display structure 100 may further comprise a second in-coupling structure 104 in/on the second waveguide 102 configured to receive at least a part of the second polarization passed through the first in-coupling structure and to couple at least some of the part of the second polarization passed through the first in-coupling structure into the second waveguide.

As illustrated in the embodiment of FIG. 1, some light 122 can pass through the second in-coupling structure 104 and the second waveguide 102.

The positioning of the first/second in-coupling structure 103, 104 illustrated in the embodiment of FIG. 1 is only exemplary and the first/second in-coupling structure 103, 104 may be positioned in various other ways. In some embodiments, the first/second in-coupling structure 103, 104 may be positioned on any surface of the first/second waveguide 101, 102. In other embodiments, the first/second in-coupling structure 103, 104 be positioned inside the first/second waveguide 101, 102.

According to an embodiment, the second in-coupling structure comprises second diffractive grating features and second sub-wavelength grating features, wherein the second diffractive grating features are configured to couple at least some of the part of the second polarization passed through the first in-coupling structure into the second waveguide, and wherein the second sub-wavelength grating features are configured to make the second diffractive grating features at least partially transparent to the first polarization.

Since some part of the first polarization can also propagate through the first in-coupling structure 103 and the first waveguide 101, some of the first polarization can reach the second waveguide 102 and/or the second in-coupling structure 104. Thus, since the second sub-wavelength grating features can make the second diffractive grating features at least partially transparent to the first polarization, at least some of the first polarization can pass through the second waveguide 102 and/or the second in-coupling structure 104. Thus, in-coupling of the first polarization into the second wave-guide 102 can be reduced.

The set of input beams 110 may be generated by, for example, a scanner-based optical engine. The set of input beams 110 may represent an image generated by, for example, such an optical engine. Thus, the set of input beams 110 may also be referred to as, for example, image-bearing light rays/beams, image-carrying light rays/beams, or similar.

According to an embodiment, the first polarization corresponds to a first wavelength range and the second polarization corresponds to a second wavelength range.

The second wavelength range may be different from the first wavelength range. For example, the first wavelength range and the second wavelength range may be at least partially non-overlapping or totally non-overlapping.

For example, the first wavelength range may correspond to the colour(s) green and/or blue and the second wavelength range may correspond to the colour red or vice versa. Alternatively, the first wavelength range may correspond to the colour(s) red and/or green and the second wavelength range may correspond to the colour blue or vice versa.

Separation of different wavelength ranges into different waveguides can be advantageous, since many optical phenomena are wavelength dependent. Thus, the optical properties of each waveguide can be designed for a narrower wavelength range compared to if a single waveguide was used.

The first in-coupling structure 103 and/or the second in-coupling structure 104 may comprise, for example, a diffractive grating on a surface of the first/second waveguide 101, 102. The first/second in-coupling structure 103, 104 may couple the set of input beams 110 into the first/second waveguide 101, 102 via diffraction.

The light coupled into the first/second wave-guide 101, 102 can be guided inside the first/second waveguide 101, 102 via total internal reflection (TIR).

Herein, a beam may also be referred to as a ray, a light beam, a light ray, or similar.

According to an embodiment, the first in-coupling structure 103 and/or the second in-coupling structure 104 is configured to diffract light via zeroth order and first order diffractions.

In any embodiment disclosed herein, the first in-coupling structure 103 and/or the second in-coupling structure 104 may comprise a diffractive grating, such as a reflective or a transmissive diffractive grating.

It should be understood that the geometry of the display structure 100 illustrated in the embodiment of FIG. 1 is only exemplary and the display structure 100 may be implemented in various other ways. For example, the distance between the first waveguide 101 and the second waveguide 102, the dimensions of the first waveguide 101 and of the second waveguide 102, and the dimensions of the first in-coupling structure 103 and of the second in-coupling structure 104 have been chosen for illustrative purposes.

FIG. 2 illustrates a schematic representation of an in-coupling structure according to an embodiment.

The embodiment of FIG. 2 can correspond to the first in-coupling structure 103 and/or to the second in-coupling structure 104.

According to an embodiment, the first diffractive grating features 201 comprise a first plurality of grating lines and the first sub-wavelength grating features 202 comprise a second plurality of grating lines.

According to an embodiment, the second diffractive grating features comprise a third plurality of grating lines and the first sub-wavelength grating features comprise a fourth plurality of grating lines.

According to an embodiment, a grating period of the first diffractive grating features 201 is greater than 250 nanometres (nm) and a grating period of the first sub-wavelength grating features 202 is less than 250 nanometres.

Alternatively or additionally, the grating period of the first diffractive grating features 201 is greater than 260 nm, 270 nm, 280 nm, 290 nm, or 300 nm.

Alternatively or additionally, the grating period of the first sub-wavelength grating features 202 is less than 240 nm, 230 nm, or 220 nm.

According to an embodiment, a grating period of the second diffractive grating features is greater than 250 nm and a grating period of the second sub-wavelength grating features is less than 250 nm.

Alternatively or additionally, the grating period of the second diffractive grating features 201 is greater than 260 nm, 270 nm, 280 nm, 290 nm, or 300 nm.

Alternatively or additionally, the grating period of the second sub-wavelength grating features 202 is less than 240 nm, 230 nm, or 220 nm.

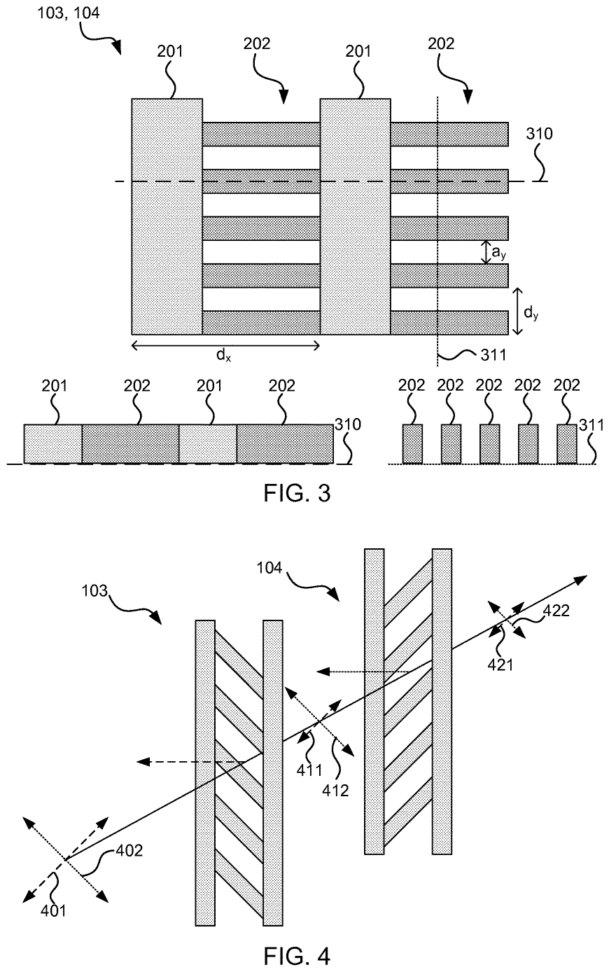

The grating period of the first/second diffractive grating features is denoted by dₓ in the embodiments of FIG. 2 and FIG. 3.

The grating period of the first/second sub-wavelength grating features is denoted by d_{y} in the embodiments of FIG. 2 and FIG. 3.

According to an embodiment, a grating period of the first diffractive grating features is 300-500.

According to an embodiment, a grating period of the second diffractive grating features is 300-500.

According to an embodiment, each grating line in the first plurality of grating lines comprises an air gap 203.

According to an embodiment, each grating line in the third plurality of grating lines comprises an air gap.

According to an embodiment, a width of each air gap in the first plurality of grating lines and/or in the third plurality of grating lines is 30-100 nm.

The width of the air gap is denoted by a, in the embodiment of FIG. 2.

According to an embodiment, the second plurality of grating lines are positioned between the first plurality of grating lines.

According to an embodiment, a distance between grating lines in each consecutive grating line pair in the second plurality of grating lines is 60-150 nm.

In the embodiments of FIG. 2 and FIG. 3, the distance between grating lines in each consecutive grating line pair in the second plurality of grating lines is denoted by a_{y}.

According to an embodiment, a width of each grating line in the second plurality of grating lines 50-160 nm.

In the embodiment of FIG. 2, cross-sections of the in-coupling structure along the dashed line 210 and along the dotted line 211 are also illustrated. For the first in-coupling structure 101, the first polarization can be along the dashed line 210 and the second polarization can be along the dotted line 211. For the second in-coupling structure 102, the first polarization can be along the dotted line 211 and the second polarization can be along the dashed line 210.

As can be seem from the cross-section along the dashed line 210, the polarization along the dashed line experiences the diffractive grating features 201 as a diffractive grating. Thus, the polarization along the dashed line 210 can be coupled into the corresponding waveguide using diffraction.

Since the sub-wavelength grating features 202 are sub-wavelength, the polarization along the dotted line 211 experiences a spatially averaged refractive index caused by the sub-wavelength grating features 202 and the material between the sub-wavelength grating features 202, such as air. This average refractive index can be tuned such that it sufficiently matches the refractive index of the material of the diffractive grating features 201. Thus, the diffractive grating features 201 can be made at least partially transparent to the second polarization in the first in-coupling structure 101 and to the first polarization in the second in-coupling structure 102.

In the embodiment of FIG. 2, for example, the diffractive grating features 201 can be made at least partially transparent to the second polarization in the first in-coupling structure 101 and to the first polarization in the second in-coupling structure 102 by tuning aₓ, dₓ, a_{y}, d_{y}, the refractive index of the material of the diffractive grating feature 201, and/or the refractive index of the material of the sub-wavelength grating feature 202. Appropriate values for at least some of these parameters can be found using, for example, optical simulations. In some cases, some of these parameters can have predetermined values and the values of the rest of these parameters can be found using optical simulations. For example, the refractive index of the material of the diffractive grating feature 201, and/or the refractive index of the material of the sub-wavelength grating feature 202 may be pre-determined by the used material(s) and aₓ, dₓ, a_{y} and/or d_{y} can be found using optical simulations.

According to an embodiment, the first sub-wavelength grating features are configured to make the first diffractive grating features at least partially transparent to the second polarization via a spatial refractive index average along a direction of the second polarization being substantially constant.

According to an embodiment, a refractive index of a material of the diffractive grating features is in the range 1.9-2.4 and a refractive index of a material of the sub-wavelength grating features is in the range 1.9-2.4.

According to an embodiment d_{y} is in the range 200-220 nm, dₓ is in the range 300-500 nm, a_{y} is in the range 60-150 nm, aₓ is in the range 30-100, a refractive index of a material of the diffractive grating features is substantially 2.4, and a refractive index of a material of the sub-wavelength grating features is substantially 2.4.

FIG. 3 illustrates a schematic representation of an in-coupling structure according to another embodiment.

The embodiment of FIG. 3 can correspond to the first in-coupling structure 103 and/or to the second in-coupling structure 104.

According to an embodiment, the first plurality of grating lines is made of a material with a first refractive index, and the second plurality of grating lines is made of a material with a second refractive index different from the first refractive index.

The first refractive index may be denoted by n₁ and the second refractive index may be denoted by n₂.

According to an embodiment, the third plurality of grating lines is made of a material with a third refractive index, and the fourth plurality of grating lines is made of a material with a fourth refractive index different from the third refractive index.

A refractive index of a material may refer to a refractive index that light experiences when the light interacts with a substantially homogeneous piece of the material. The refractive index of a material may be wavelength dependent. It should be appreciated that an effective refractive index caused by, for example, the sub-wavelength grating features 202 can differ from the refractive index of the material of which the sub-wavelength grating features 202 are made of due to the sub-wavelength grating features 202 having a sub-wavelength size. Since the sub-wavelength grating features 202 have a sub-wavelength size, the light experiences a spatially averaged effective refractive index that depends on the relative orientation of the sub-wavelength grating features 202 and the polarization of the light. Thus, the effective refractive index of the sub-wavelength grating features 202 is anisotropic and polarization dependent.

In the embodiment of FIG. 3, cross-sections of the in-coupling structure along the dashed line 310 and along the dotted line 311 are also illustrated. For the first in-coupling structure 101, the first polarization can be along the dashed line 310 and the second polarization can be along the dotted line 311. For the second in-coupling structure 102, the first polarization can be along the dotted line 311 and the second polarization can be along the dashed line 310.

As can be seem from the cross-section along the dashed line 310, the polarization along the dashed line 310 experiences the diffractive grating features 201 as a diffractive grating. Thus, the polarization along the dashed line 310 can be coupled into the corresponding waveguide using diffraction.

Since the sub-wavelength grating features 202 are sub-wavelength, the polarization along the dotted line 311 experiences a spatially averaged refractive index caused by the sub-wavelength grating features 202 and the material between the sub-wavelength grating features 202, such as air. This average refractive index can be tuned such that it sufficiently matches the refractive index of the material of the diffractive grating features 201. Thus, the diffractive grating features 201 can be made at least partially transparent to the second polarization in the first in-coupling structure 101 and to the first polarization in the second in-coupling structure 102.

In the embodiment of FIG. 3, for example, the diffractive grating features 201 can be made at least partially transparent to the second polarization in the first in-coupling structure 101 and to the first polarization in the second in-coupling structure 102 by tuning dₓ, a_{y}, d_{y}, the refractive index of the material of the diffractive grating feature 201, and/or the refractive index of the material of the sub-wavelength grating feature 202. Appropriate values for at least some of these parameters can be found using, for example, optical simulations. In some cases, some of these parameters can have predetermined values and the values of the rest of these parameters can be found using optical simulations. For example, the refractive index of the material of the diffractive grating feature 201, and/or the refractive index of the material of the sub-wavelength grating feature 202 may be pre-determined by the used material(s) and dₓ, a_{y} and/or d_{y} can be found using optical simulations.

According to an embodiment, each grating line in the first plurality of grating lines comprises an air gap 203, the first plurality of grating lines is made of a material with a first refractive index, and the second plurality of grating lines is made of a material with a second refractive index different from the first refractive index. Thus, the embodiments of FIG. 2 and FIG. 3 may be combined into another embodiment.

FIG. 4 illustrates a schematic representation of in-coupling structures and polarizations according to an embodiment.

In the embodiment of FIG. 4, two grating lines of the diffractive grating features and some grating lines of the sub-wavelength grating features between the grating lines of the diffractive grating features are illustrated for clarity purposes. In practical implementations, the diffractive grating features and the sub-wavelength grating features can comprise significantly greater number of grating lines.

According to an embodiment, first sub-wavelength grating features and second sub-wavelength grating features are substantially orthogonal.

Herein, when the first sub-wavelength grating features and second sub-wavelength grating features are substantially orthogonal, a grating vector of the first sub-wavelength grating features and a grating vector of the second sub-wavelength grating features may be substantially orthogonal. For example, if the first sub-wavelength grating features comprise the first plurality of grating lines and the second sub-wavelength grating features comprise the third plurality of grating lines, the first plurality of grating lines and the third plurality of grating lines may be substantially orthogonal. Alternatively or additionally, if the first sub-wavelength grating features and the second sub-wavelength grating features comprise other types of gratings, such as two-dimensional gratings, the grating vectors of those gratings can be substantially orthogonal.

According to an embodiment, the first plurality of grating lines and the second plurality of grating lines are non-parallel.

According to an embodiment, the third plurality of grating lines and the fourth plurality of grating lines are non-parallel.

For example, in the embodiments of FIG. 2, FIG. 3, and FIG. 4, the first plurality of grating lines and the second plurality of grating lines are non-parallel. For example, the first plurality of grating lines and the second plurality of grating lines may be substantially orthogonal such as in the embodiments of FIG. 2 and FIG. 3. Alternatively, the first plurality of grating lines and the second plurality of grating lines can be in any other non-parallel orientation such as is illustrated in the embodiment of FIG. 4.

According to an embodiment, the first polarization 401 and the second polarization 402 are substantially orthogonal.

As illustrated in the embodiment of FIG. 4, part of the first polarization 401 in the set of input beams 110 may be in-coupled into the first waveguide 101 by the first in-coupling structure 103 while a part 411 of the first polarization can pass through the first waveguide 101 and the first in-coupling structure 103.

Similarly, only a part of the second polarization 402 in the set of input beams 110 may pass through the first waveguide 101 and the first in-coupling structure 103 due to, for example, optical losses. Further, the second in-coupling structure 104 may receive only some part of the second polarization 412 that passed through the first in-coupling structure 103 due to, for example, light scattering to other direction and thus not reaching the second waveguide 102, and/or various other optical phenomena.

The second in-coupling structure 104 may couple only some of the part of the second polarization 412 passed through the first in-coupling structure 103 into the second waveguide 102. Some of the second polarization 412 can, for example, pass through the second in-coupling structure 104. Thus, the light passing through the second in-coupling structure 104 can comprise at least some of the first polarization 421 and some of the second polarization 422 as illustrated in the embodiment of FIG. 4.

In some embodiments, the first in-coupling structure 103 and the second in-coupling structure 104 may comprise similar diffractive grating features 201 and/or similar sub-wavelength grating features 202. For example, the first diffractive grating features and the second diffractive grating features may have similar or substantially the same dimensions. Alternatively, properties the first/second diffractive grating features, such as the dimensions, may be optimized according to, for example, the wavelength range that is to be coupled to the corresponding waveguide. For example, the first in-coupling structure 103 can be designed according to the first wavelength range and the second in-coupling structure 104 can be designed according to the second wavelength range.

In some embodiments, the first sub-wavelength grating features and the second sub-wavelength grating features may have similar or substantially the same dimensions, while the relative orientation of the first sub-wavelength grating features and the second sub-wavelength grating features may be such that the desired polarization selectivity is achieved. For example, the first sub-wavelength grating features and the second sub-wavelength grating features may be substantially orthogonal.

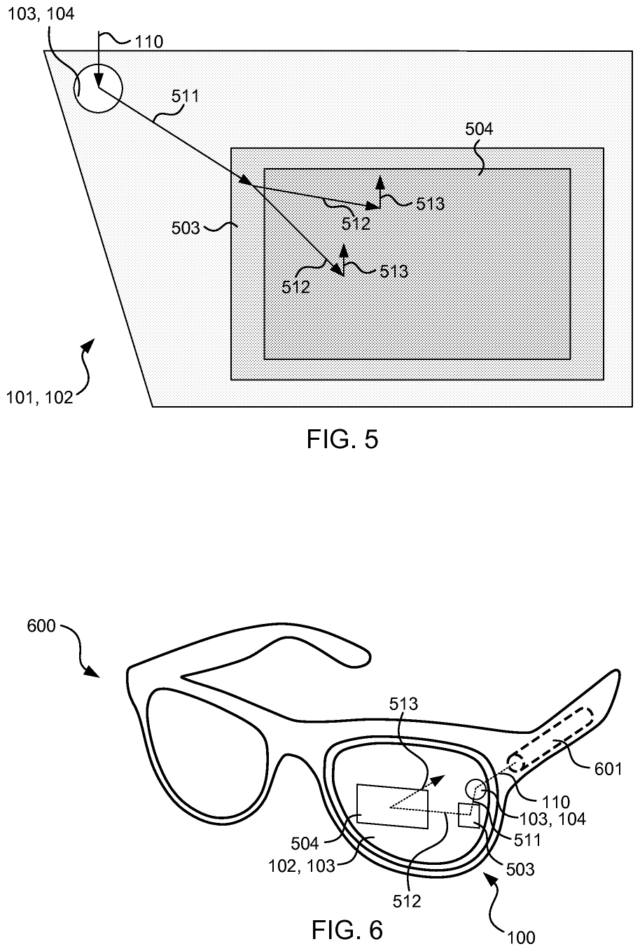

FIG. 5 illustrates a schematic representation of a waveguide according to an embodiment.

The waveguide illustrated in the embodiment of FIG. 5 can correspond to the first waveguide 101 and/or to the second waveguide 102. The first waveguide 101 can be configured to perform the functionality disclosed herein in relation to the embodiment of FIG. 5 for light coupled into the first waveguide 101, such as the first polarization. Similarly, the second waveguide 102 can be configured to perform the functionality disclosed herein in relation to the embodiment of FIG. 5 for light coupled into the second waveguide 102, such as the second polarization.

The in-coupling structure 103, 104 can couple a part of the set of input beams 110 into the corresponding waveguide 101, 102 as a set of in-coupled beams 511. For example, the first in-coupling structure 103 can couple at least part of the first polarization into the first waveguide 101 and the second in-coupling structure can couple at least part of the second polarization into the second waveguide 102.

The waveguide 101, 102 may further comprise an exit pupil expansion (EPE) structure 503 configured to receive the set of in-coupled beams 511 and to diffract the set of in-coupled beams 511 in a plurality of directions, producing a set of diffracted beams 512.

It should be appreciated that the set of diffracted beams 512 illustrated in the embodiment of FIG. 5 are only illustrative. In practical embodiments, the EPE structure 503 can diffract the set of in-coupled beams 511 in a plurality of directions in a much more complex manner and the set of diffracted beams 512 can interact with the EPE structure 503 a plurality of times.

The display structure 500 may further comprise an out-coupling structure 504 configured to receive, from the EPE structure 503, at least the set of diffracted beams 512 and to out-couple at least the set of diffracted beams 512 from the planar waveguide 201 as a set of output beams 513.

The set of output beams 513 may represent, for example, an expanded version of the image formed by the set of input beams 110.

The set of in-coupled beams 511 and the set of diffracted beams 512 can be guided inside the waveguide 101, 102 via total internal reflection (TIR).

The in-coupling structure 103, 104, the EPE structure 503 and/or the out-coupling structure 504 may comprise, for example, a diffractive grating on a surface of the planar waveguide 201. The in-coupling structure out-coupling may couple the set of input beams 110 into the planar waveguide 201 via diffraction. The EPE structure 503 may expand the image corresponding to the set of in-coupled beams 511 via diffraction. The out-coupling structure 504 may out-couple the set of diffracted beams 512 from the planar waveguide 201 via diffraction.

FIG. 6 illustrates a schematic representation of a display device according to an embodiment.

According to an embodiment, a display device 600 comprises the display structure 100.

According to an embodiment, the display device 600 further comprises an optical engine 601 for directing the set of input beams 110 to the first in-coupling structure 103.

According to an embodiment, the optical engine 601 is configured to generate the set of input beams 110 in a manner that the first polarization comprises a first wavelength range and the second polarization comprises a second wavelength range.

When the first polarization comprises a first wavelength range and the second polarization comprises a second wavelength range, the first wavelength range and the second wavelength range can be separated into different waveguides. Thus, each waveguide can be designed for the corresponding wavelength range and the image quality produced by the display device 600 can be improved compared to solutions using a single waveguide.

According to an embodiment, the display device 600 is implemented as a see-through display device.

According to an embodiment, the display device 600 is implemented as a head-mounted display device.

For example, in the embodiment of FIG. 6, the display device 600 is implemented as smart glasses. The first waveguide 101 and the second waveguide 102 can correspond to layers of a lens of such smart glasses. Such smart glasses may be used to, for example, implement augmented reality (AR) and/or virtual reality (VR) functionality.

In the embodiment of FIG. 6, the set of input beams 110 may be generated by, for example, an optical engine 601, such as a scanner-based optical engine. The set of input beams 110 may represent an image generated by, for example, such an optical engine. The display structure 100 of the display device 600 can direct the set of output beams 513 representing the image generated by the optical engine 601 into the eye of a user.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A display structure (100), comprising:
a first waveguide (101);
a second waveguide (102);
a first in-coupling structure (103) in/on the first waveguide (101) comprising first diffractive grating features (201) and first sub-wavelength grating features (202) and configured to receive a set of input beams (110) comprising a first polarization (401) and a second polarization (402), wherein the first diffractive grating features (201) are configured to couple at least part of the first polarization (401) into the first waveguide (101), and wherein the first sub-wavelength grating features (202) are configured to make the first diffractive grating features (201) at least partially transparent to the second polarization (402) ; and
a second in-coupling structure (104) in/on the second waveguide (102) configured to receive at least a part of the second polarization passed through the first in-coupling structure (103) and to couple at least some of the part of the second polarization passed through the first in-coupling structure (103) into the second waveguide (102).

2. The display structure (100) according to claim 1, wherein the second in-coupling structure comprises second diffractive grating features and second sub-wavelength grating features, wherein the second diffractive grating features are configured to couple at least some of the part of the second polarization passed through the first in-coupling structure into the second waveguide, and wherein the second sub-wavelength grating features are configured to make the second diffractive grating features at least partially transparent to the first polarization.

3. The display structure (100) according to claim 2, wherein first sub-wavelength grating features and second sub-wavelength grating features are substantially orthogonal.

4. The display structure (100) according to claim 2, wherein the first sub-wavelength grating features are configured to make the first diffractive grating features at least partially transparent to the second polarization via a spatial refractive index average along a direction of the second polarization being substantially constant.

5. The display structure (100) according to claim 2, wherein the first diffractive grating features comprise a first plurality of grating lines and the first sub-wavelength grating features comprise a second plurality of grating lines.

6. The display structure (100) according to claim 5, wherein a grating period of the first diffractive grating features is greater than 250 nanometres and a grating period of the first sub-wavelength grating features is less than 250 nanometres.

7. The display structure (100) according to claim 5, wherein each grating line in the first plurality of grating lines comprises an air gap.

8. The display structure (100) according to claim 5, wherein the first plurality of grating lines is made of a material with a first refractive index, and the second plurality of grating lines is made of a material with a second refractive index different from the first refractive index.

9. The display structure (100) according to claim 5, wherein the second plurality of grating lines are positioned between the first plurality of grating lines.

10. The display structure (100) according to claim 5, wherein the first plurality of grating lines and the second plurality of grating lines are non-parallel.

11. The display structure (100) according to claim 5, wherein the first polarization and the second polarization are substantially orthogonal.

12. The display structure (100) according to claim 5, wherein the first polarization corresponds to a first wavelength range and the second polarization corresponds to a second wavelength range.

13. A display device (600) comprising a display structure (100) according to claim 5.

14. The display device (600) according to claim 13, further comprising an optical engine (601) for directing the set of input beams (110) to the first in-coupling structure (103).

15. The display device (600) according to claim 14, wherein the optical engine (601) is configured to generate the set of input beams (110) in a manner that the first polarization (401) comprises a first wavelength range and the second polarization (402) comprises a second wavelength range.

16. A diffractive grating (103, 104) comprising first diffractive grating features (201) and first sub-wavelength grating features (202) wherein the first diffractive grating features comprise a first plurality of grating lines and the first sub-wavelength grating features comprise a second plurality of grating lines and the second plurality of grating lines are positioned between the first plurality of grating lines.

17. The diffractive grating (103, 104) according to claim 16, wherein a grating period of the first diffractive grating features is greater than 250 nanometres and a grating period of the first sub-wavelength grating features is less than 250 nanometres.

18. The diffractive grating (103, 104) according to claim 16, wherein each grating line in the first plurality of grating lines comprises an air gap.

19. The diffractive grating (103, 104) according to claim 16, wherein the first plurality of grating lines is made of a material with a first refractive index, and the second plurality of grating lines is made of a material with a second refractive index different from the first refractive index.

20. The diffractive grating according to claim 16, wherein the first plurality of grating lines and the second plurality of grating lines are non-parallel.
